(19) United States
(12) Patent Application Publication
(10) Pub. No.: US 2012/0294700 A1
(43) Pub. Date: Nov. 22, 2012

(54) CANOPY CRANE

(76) Inventor: Michael D. Ervin, Rochester, WA (US)

(21) Appl. No.: 13/474,463

(22) Filed: May 17, 2012

Related U.S. Application Data
(60) Provisional application No. 61/487,586, filed on May 18, 2011.

(51) Int. Cl. B66C 23/44; B66F 7/26; B60P 1/54

(52) U.S. Cl. 414/550; 254/46; 414/812

(57) ABSTRACT

A crane having a base unit, a mast, a boom, a support, and an elevator mechanism is disclosed. The base unit couples to a hitch of a vehicle, such as a pickup truck. The mast extends from the base unit, and the boom extends from the mast. The support is coupled to a distal end of the boom and is configured to engage a load, such as a canopy for the pickup truck. The elevator mechanism is configured to elevate the boom to life the load relative to the vehicle. The boom and the elevator assembly are rotatable about the mast.

### PRIORITY CLAIM

This application claims the benefit of prior U.S. provisional application Ser. No. 61/487,586 filed May 18, 2011, the contents of which are hereby incorporated by reference.

### FIELD OF THE INVENTION

The present disclosure relates to cranes for installing and removing attachments to vehicles, such as canopies for pick-up trucks.

### BACKGROUND OF THE INVENTION

Attachments to vehicles, such as canopies for pick-up trucks, are heavy, large, and unwieldy structures that are virtually impossible to install or remove without two or three people helping. Other structures, such as camper tops, are even larger and heavier and may require using heavy-duty cranes or other specialized equipment for removal. In addition to being large and heavy, these attachments are usually somewhat fragile and not especially able to withstand being dropped to the ground. There is a need for a way to install and remove these vehicle attachments without damaging the attachment and without requiring multiple people helping or expensive, specialized equipment.

### SUMMARY OF THE INVENTION

The present invention is directed to a crane for an attachment to a vehicle. The crane includes a base stem attachable to a vehicle hitch, and a mast extending upwardly from the base unit. The crane also has a boom with a proximal end pivotably mounted to the mast and a distal end extending from the mast. The boom has a transverse lateral axis and is pivotable about the transverse lateral axis to raise and lower the distal end of the boom. The boom is also pivotable about the axis of the mast. The crane also has a support coupled to the distal end of the boom and configured to engage the attachment, and a lift coupled to the boom to elevate the distal end of the boom to raise the attachment away from the vehicle. The boom is further configured to pivot about the axis of the mast to move the attachment on or off the vehicle. The support includes a support base and one or more extension arms extensibly coupled to the support base. The extension arms are movable between an extended position and a retracted position. The support also includes attachment engagement pads coupled to ends of the extension arms and configured to engage the attachment to lift the attachment relative to the vehicle.

In other embodiments the present invention is directed to a method of installing an attachment to a vehicle, including securing a crane base unit to a hitch of the vehicle and positioning a boom of the crane relative to the attachment to support the attachment with a support engaging the attachment. The method also includes elevating the boom of the crane with the support engaging the attachment, rotating the boom relative to the crane to align the attachment with the vehicle, and lowering the boom and the support and securing the attachment to the vehicle.

In still further embodiments the present invention is directed to a crane having a base configured to attach to a hitch of a vehicle and an extendible mast extending upwardly from the base and being upwardly extendible. The crane also has an extendible boom with a proximal end and a distal end, the extendible boom extending from the mast at an adjustable angle with the proximal end coupled to the mast. The crane also includes a support coupled to the distal end of the boom, the support comprising a support base and extendible arms, the extendible arms being retractable and extendable from the support base. The crane includes a mechanical lift coupled to the mast and the boom and configured to raise the boom and the support. The support and the extendible boom are configured to rotate about the mast while carrying a load.

### BRIEF DESCRIPTION OF THE DRAWINGS

Preferred and alternative examples of the present invention are described in detail below with reference to the following drawings:

FIGS. 1A and 1B are side isometric and top perspective views of a canopy crane and vehicle according to embodiments of the present disclosure.

FIG. 2 is a side view of a canopy crane according to embodiments of the present disclosure.

FIG. 3 is a side view of a canopy crane according to embodiments of the present disclosure.

FIG. 4 is a side view of a canopy crane in a collapsed state according to embodiments of the present disclosure.

FIG. 5 is a top view of a support of the canopy crane in a collapsed state according to embodiments of the present disclosure.

FIG. 6 is a side view of a pad for the canopy crane of the present disclosure.

FIGS. 7A and 7B are views of a swivel platform assembly for use with a support according to embodiments of the present disclosure.

FIGS. 8A and 8B are top and side views, respectively, of a base unit and mast for the canopy crane of the present disclosure.

FIG. 9 is an isometric view of an offset extension assembly for the canopy crane of the present disclosure.

FIG. 10 illustrates a crane having a hook attachment according to embodiments of the present disclosure.

FIGS. 11A-11C illustrate a crane with an extensible mast according to embodiments of the present disclosure.

FIGS. 12A-12C illustrate a crane with an extensible boom according to embodiments of the present disclosure.

FIGS. 13A-13C illustrate a crane with an extensible mast and pivotable boom according to embodiments of the present disclosure.

FIGS. 14A-14C illustrate a support being pivotably movable relative to a boom according to embodiments of the present disclosure.

FIGS. 15A-15D illustrate a crane in operation according to embodiments of the present disclosure.

### DETAILED DESCRIPTION OF THE PREFERRED EMBODIMENT

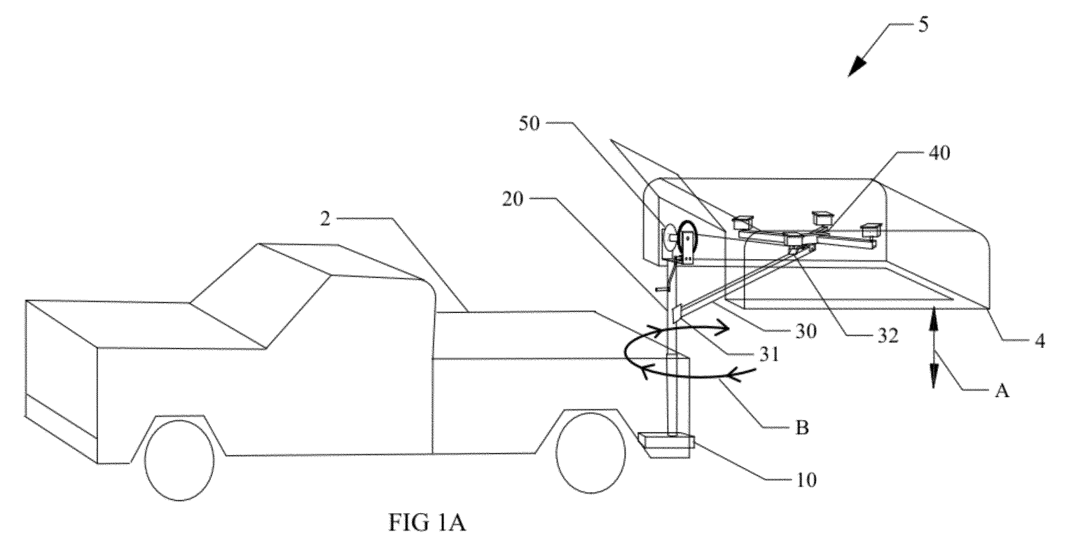

FIGS. 1A and 1B are side isometric and top perspective views of a canopy crane 5 according to embodiments of the present disclosure. The canopy crane 5 can be used with a vehicle 2 having an attachment 4, such as a canopy or camper. The vehicle 2 can be a pick-up truck or any other suitable vehicle capable of supporting such an attachment. The canopy crane includes a base unit 10, a mast 20, a boom 30 extending from the mast 20, and a support 40 coupled to the boom 30. The boom 30 has a proximal end 31 near the mast 20 and a distal end 32 opposite the proximal end 31. The support 40 is coupled to the distal end 32 of the boom 30. The canopy crane 5 also includes an elevator mechanism 50 coupled to the mast 20 and to the boom 30 and configured to elevate the support 40 as shown by arrow A. The mast 20 is pivotably mounted to the base unit 10 to permit the crane to pivot relative to the base unit 10 as shown by arrow B. The support 40 permits the attachment to rotate relative to the boom 30 to facilitate positioning the attachment 4 relative to the vehicle 2. In operation, to mount the attachment 4 to the vehicle, the crane 5 is mounted to the vehicle 2 and the mast 20 and boom 30 are positioned relative to the attachment 4 with the support 40 engaging and supporting the attachment 4. The elevator mechanism 50 mechanically elevates the support 40 and the attachment 4 and rotates the boom 30, support 40, and attachment 4 into position relative to the vehicle 2. The elevator mechanism 50 then lowers the attachment 4 onto the vehicle 2. The attachment 4 can then be secured to the vehicle 2 and the crane 5 can be removed and collapsed for storage.

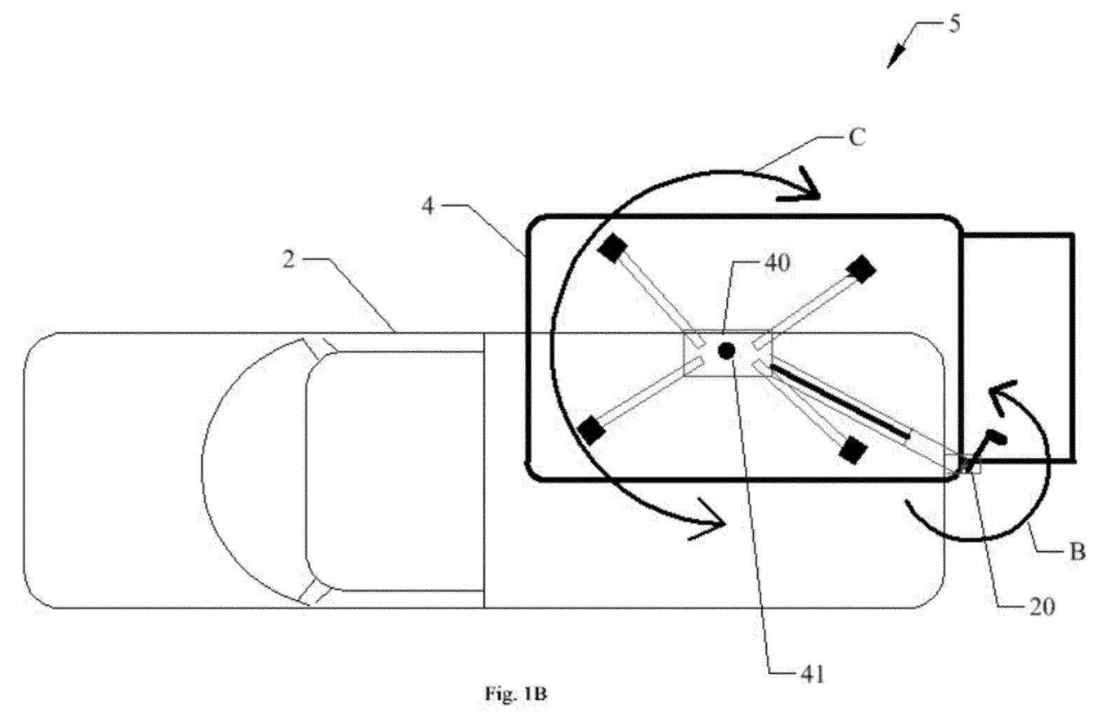

FIG. 2 is a side view of the canopy crane 5 of FIG. 1 according to embodiments of the present disclosure. The base unit 10 is an L-shaped member that can attach to a receiver hitch of the vehicle 2. In other embodiments, the base unit 10 can attach to the vehicle 2 using another type of hitch or to the ground or another structure to support the canopy crane 5. The base unit 10 includes a crank 12 that drives the mast 20 up and down relative to the base unit 10. The crank 12 can use a threaded engagement or any other suitable mechanical means to drive the mast 20 up and down. The mast 20 extends generally vertically upwardly from the base unit 10 and supports the elevator mechanism 50. The elevator mechanism 50 can be a manual winch having a handle 13, an electromechanical winch, or another type of mechanical elevator. The mast 20 can include a mast sleeve 22 that can move along the mast 20 and can be secured to the mast 20 at any of a plurality of attachment points on the mast 20. The mast sleeve 22 has a boom pivot 24 extending therefrom. The boom pivot 24 is pivotably connected to the boom 30 at a proximal end 31 of the boom 30. The boom 30 may include a boom base 33 at a proximal end 31 of the boom 30.

The boom 30 has a wedge-shaped swivel platform at the distal end 32 of the boom 30. The swivel platform 60 has an eyelet 61 that is coupled to the elevator mechanism 50 by a cable 62. When the elevator mechanism 50 shortens the cable 62, the boom 30 pivots about the boom pivot 24 as shown by the arrow A, thus raising the distal end of the boom 30. The mast sleeve 22 can be positioned as near to or far from the elevator mechanism 50 to provide the elevator mechanism 50 with sufficient leverage.

The support 40 is coupled to the distal end 32 of the boom 30 by a stabilizer axle 41 or pin extending generally vertically through the center of the support 40 and through a hole in the distal end 32 of the boom 30, and/or through the swivel platform 60. The support 40 comprises a support base 42 and extension arms 43 pivotably coupled to the support base 42. The extension arms 43 have pads 44 coupled to the arms 43 and configured to engage the attachment 4. The pads 44 can be shaped according to the attachment 4 to be installed. In many cases the attachment has a flat interior surface, so the pads 44 can be generally flat and slightly resilient and skid-proof. In other embodiments, the pads 44 can include a threaded fastener that threadably couples with the attachment 4, or another suitable attachment mechanism.

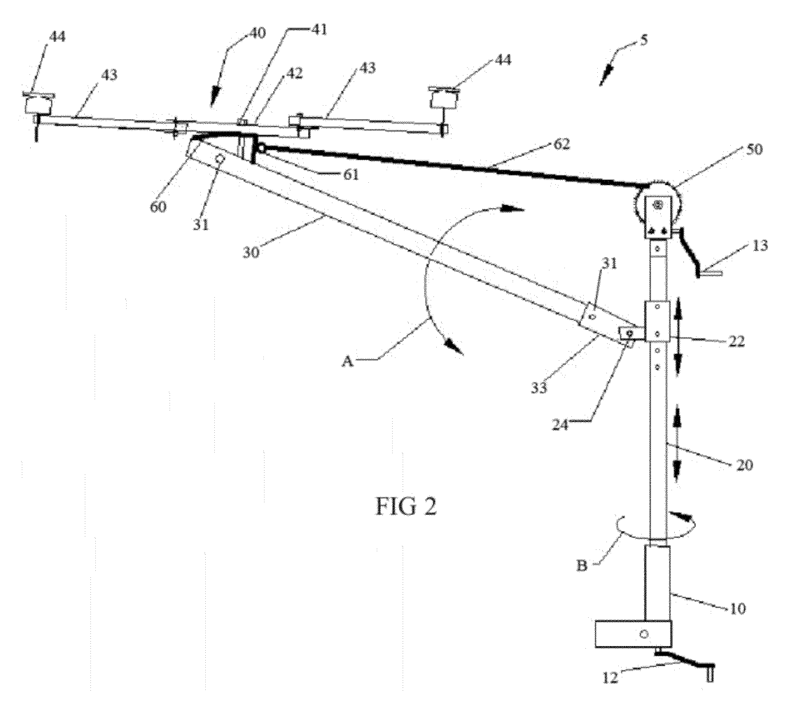

FIG. 3 is a side view of a canopy crane 5 according to embodiments of the present disclosure. In the illustrated embodiment, in addition to the components listed above with respect to FIG. 2, the crane 5 includes a leveler assembly 70 comprising a leveler base 71 and a leveler arm 72 having a proximal end 73 and a distal end 74. The leveler base 71 is a generally vertical member pivotably coupled to the distal end 32 of the boom 30 via a lower leveler base pivot 77 and to the leveler arm 72 via a distal leveler arm pivot 75. The proximal end 73 of the leveler arm 72 is coupled to the mast sleeve 22 via a proximal leveler arm pivot 76. The leveler base 71, leveler arm 72, the boom 30, and the mast sleeve 22 form a four-bar linkage. To raise the distal end of the boom 30 and leveler arm 72 the elevator mechanism 50 retracts the cable 62. The action of the linkage maintains the support 40 in a generally horizontal orientation relative to the ground to support the attachment 4.

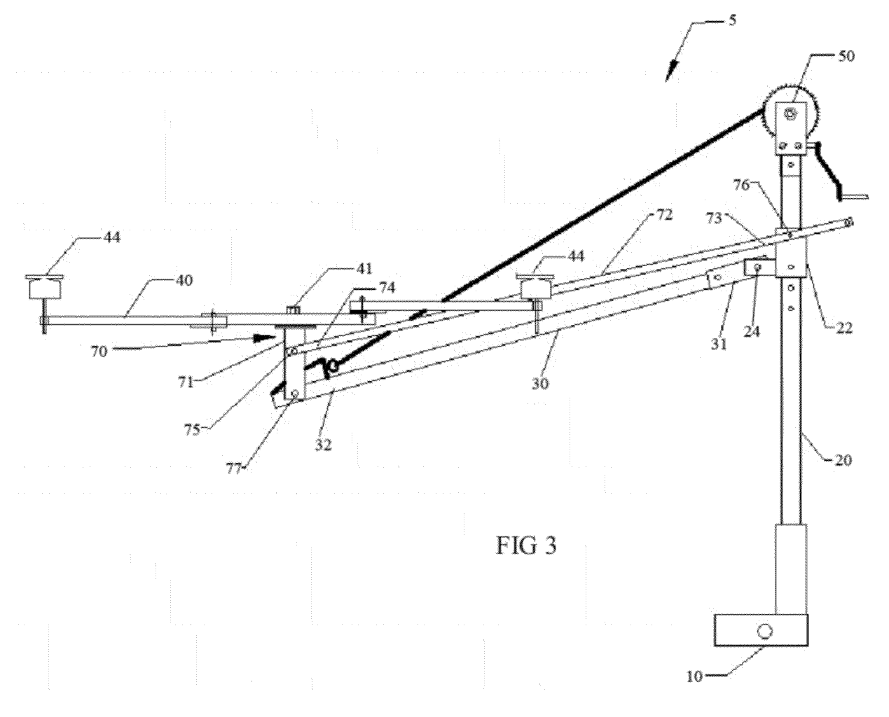

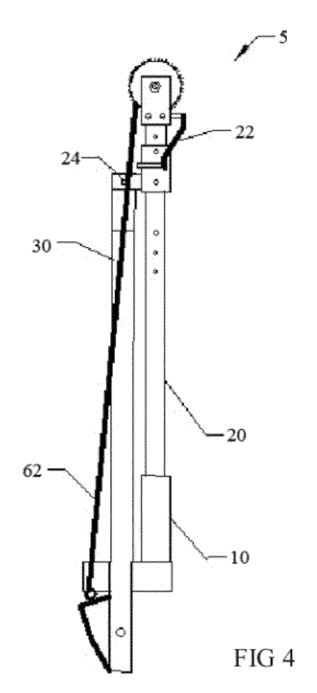

FIG. 4 is a side view of a canopy crane 5 in a collapsed state according to embodiments of the present disclosure. The canopy crane 5 can be collapsed by pivoting the boom 30 to be parallel with the mast 20 for convenient storage. The crane 5 can be removed from attachment with the vehicle 2 or with the ground or another support structure. The crane 5 therefore permits simple installation and removal from the vehicle 2 that can be performed by a single person without requiring excessive expertise, dexterity, or strength. FIG. 5 is a top view of a support 40 of the canopy crane 5 in a collapsed state according to embodiments of the present disclosure. The extension arms 43 can be pivoted relative to the support base 42 to collapse the support 40 for storage. The support 40 can include extension arm pins 45 that lock the extension arms 43 in place in the extended position, the collapsed position, or selectively in the extended or collapsed positions. In the picture embodiment the support 40 includes four extension arms 43 that can be positioned at approximately 90° relative to one another as shown in FIG. 1B. In other embodiments the support 40 includes another number of extension arms 43. For stability, three or more arms is preferred; however, depending on the attachment 4 or other object to be carried by the crane 5, the support 40 can include two, one, or zero extension arms 43.

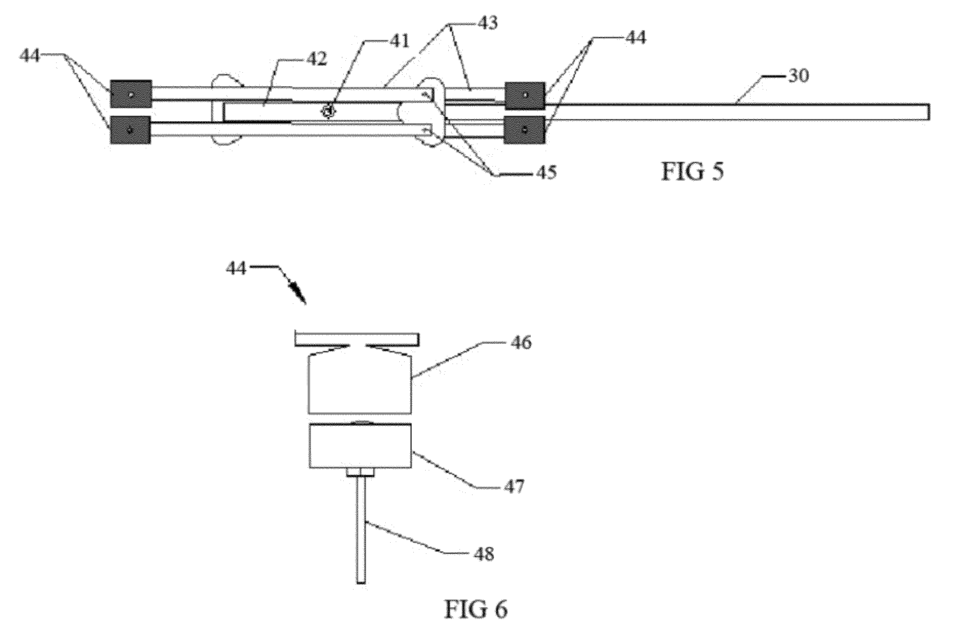

FIG. 6 is a side view of a pad 44 for the canopy crane of the present disclosure. The pads 44 include an engagement portion 46, a support 47, and an adjuster 48. The adjuster 48 couples to one of the extension arms 43 with a bolt or another suitable coupler. The support 47 can be a rigid member, such as a plastic or metal structure to support the engagement portion 46. The engagement portion 46 can have any suitable shape according to the attachment 4 with which the crane 5 is to be used. In general, the engagement portion 46 is a resilient, skid-proof member that has a wide engagement area to distribute the pressure over a greater area of the attachment 4.

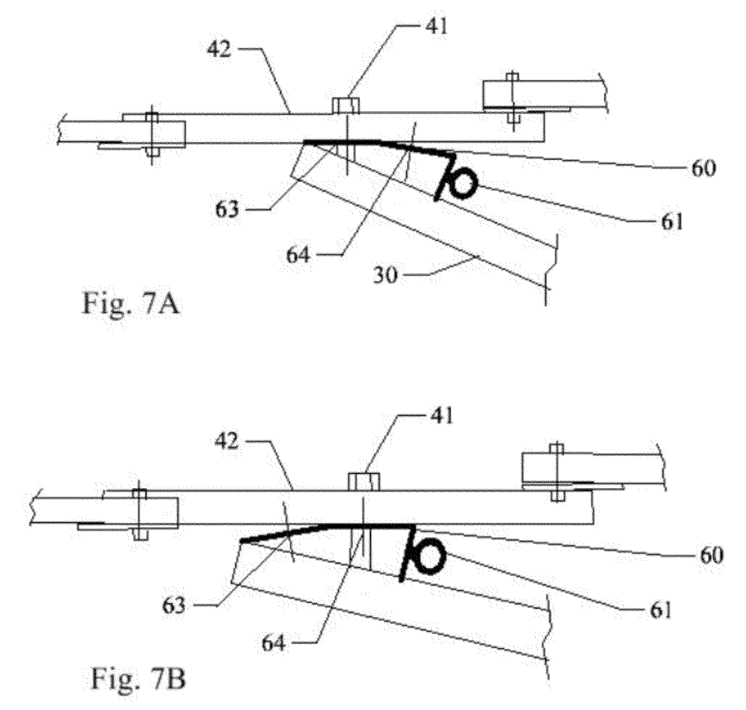

FIGS. 7A and 7B are views of a swivel platform 60 for use with a support base 42 according to embodiments of the present disclosure. The swivel platform 60 has a wedge shape with a first platform 63, and a second platform 64 at slightly different angles relative to the boom 30. The swivel platform 60 has a slot (not shown) generally parallel with the boom 30 that receives the stabilizer axle 41 and permits the support base 42 to move parallel to the boom 30. As the boom 30 moves up and down, the swivel platform 60 supports the support base 42 generally in a horizontal orientation relative to the ground. As shown in FIG. 7A, the boom 30 is raised high enough that the first platform 63 supports the support base 42. In FIG. 7B the boom 30 is in a lower position and the support base 42 rests on the second platform 64. In other embodiments, the swivel platform 60 can have any suitable number of platform areas to support the support base 42 when the boom 30 is oriented at a variety of angles relative to vertical.

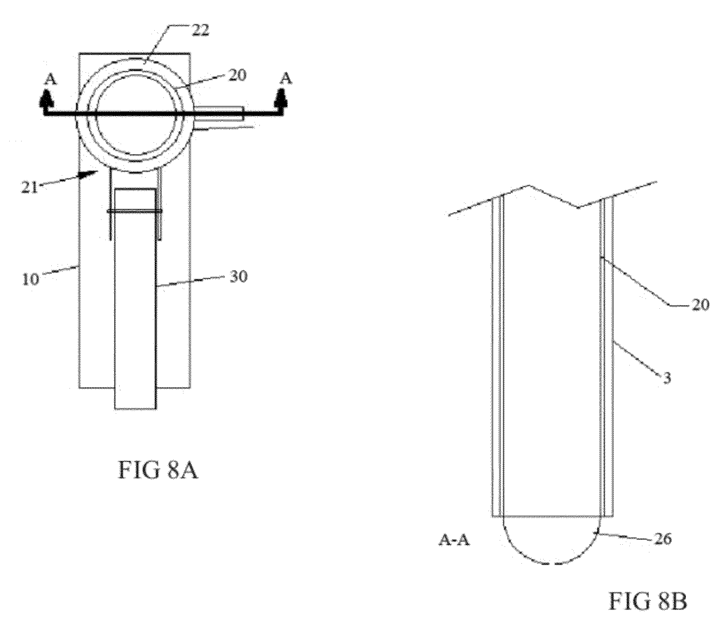

FIGS. 8A and 8B are top and side views, respectively, of a base unit 10 and mast 20 for the canopy crane 5 of the present disclosure. The base unit 10 supports the mast 20 and the mast sleeve 22. The mast 20 and mast sleeve 22 can be round members to permit rotation about a vertical axis to pivot the crane 5 and attachment 4 onto or away from the vehicle 2 (best seen in FIGS. 1A and 1B). FIG. 8B is a partial cross sectional view of the mast 20 and mast sleeve 22. The mast 20 has a rounded end 26 to minimize frictional resistance to the mast 20 rotating within the base unit 10. The base unit 10 can have a concave section to receive the rounded end 26 of the mast 20. In other embodiments, the base unit 10 can be simply flat such that the rounded end 26 contacts a very small area on the base unit 10.

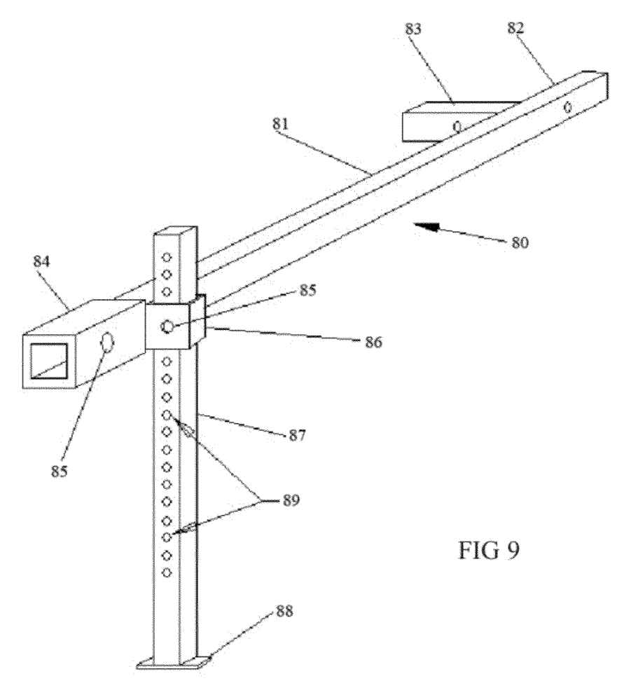

FIG. 9 is an isometric view of an offset extension assembly 80 for the canopy crane 5 of the present disclosure. The offset extension assembly 80 can provide further support to the crane 5 as needed, particularly for large attachments. The offset extension assembly 80 can also permit the crane 5 to operate when the bed of the pick-up truck is down. The offset extension assembly 80 includes an offset body 81 having an end hitch mount 82 and a side hitch mount 83 at a first end of the offset body 81. In some embodiments, the offset extension assembly 80 has both the end hitch mount 82 and the side hitch mount 83; in other embodiments the assembly includes only the end hitch mount 82 or only the side hitch mount 83. The side/end hitch mounts 82 and 83 are configured to engage with the hitch of the vehicle 2, such as a receiver hitch or another suitable vehicle hitch mechanism. At the other end of the offset body 81 is a base receiver 84 having a pinhole 85 for engaging and supporting a base unit 10 of the crane 5 as disclosed herein above. The offset body 81 also includes an extension sleeve 86 and an extension leg 87 coupled to the offset body 81 through the extension sleeve 86. The extension leg 87 has several adjustment holes 98 that can secure the extension leg 87 to the extension sleeve 86 via a pinhole 90 in the extension sleeve 86. The extension leg 87 also includes a foot 88 that supports the crane 5. The offset extension assembly 80 is better suited for mounting or dismounting larger attachments, or where it is desirable to position the mast 20 of the crane 5 offset from the hitch mount. For example, if the attachment extends rearwardly beyond the tailgate of the truck, the offset extension assembly 80 can be used with an end hitch mount 82 and an offset body having sufficient length to extend beyond the rear of the attachment. Alternatively, if the attachment is configured such that the mast 20 of the crane 5 should be offset to the side of the vehicle's hitch, the side hitch mount 83 can be used.

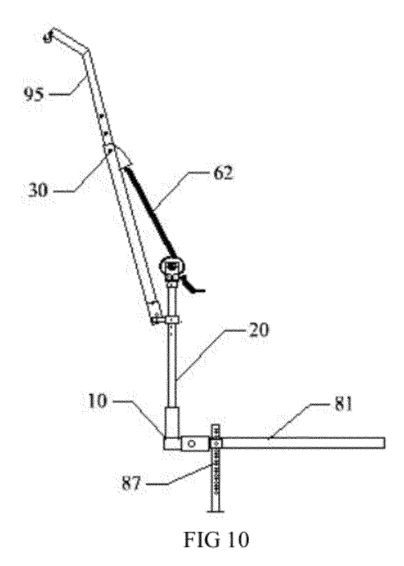

FIG. 10 illustrates a crane 5 having a hook end according to embodiments of the present disclosure. In addition to the support 40 used to engage a vehicle attachment such as a canopy or a camper, the crane 5 can be used to lift virtually any other equipment or cargo. As shown in FIG. 10, the crane 5 has a hook 95 coupled to the boom 30. In still other embodiments, the crane 5 can have other attachments that enable the crane 5 to be used as a general purpose crane. In an example, the crane 5 can be carried in a pick-up truck during a hunting trip. Because the crane 5 is relatively light and compact when collapsed it can be easily carried even to remote areas and deployed when necessary, such as to hoist game into the truck. Once the game is hoisted into the truck the crane 5 can be quickly disassembled and stowed. This permits a single person to carry heavy equipment or cargo without requiring extensive expertise, dexterity, or manpower.

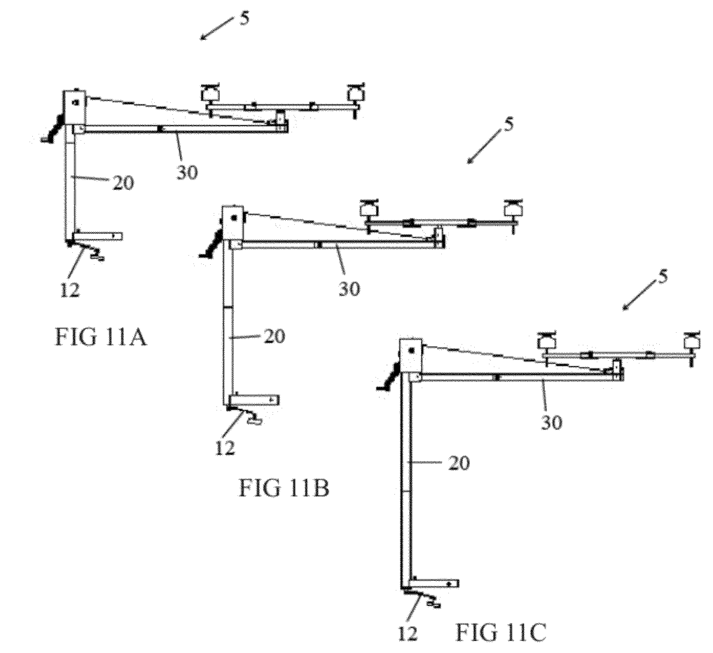

FIGS. 11A-11C illustrate a further embodiment of a crane 5 according to the present disclosure in which the mast 20 is extensibly adjustable. In FIG. 11A, the mast 20 is fully shortened for ease of storage and portability. In FIG. 11B, the mast 20 is partially extended, and in FIG. 11C the mast 20 is fully extended. The mast 20 can be adjusted up and down by turning a crank 12 that is threadably engaged with the mast 20. The mast 20 can have two, three, or any other suitable number of extending portions, such as telescoping portions, depending on the extent to which the mast 20 is designed to extend, and on the type of load the crane 5 is intended to lift.

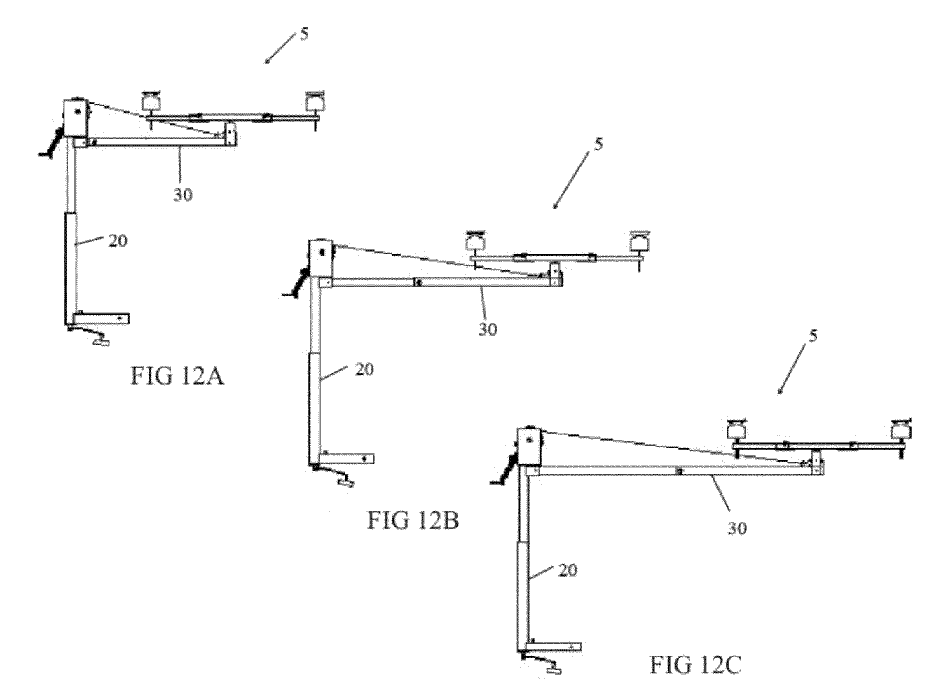

FIGS. 12A-12C illustrate yet another embodiment of the crane 5 of the present disclosure in which the boom 30 is extensibly adjustable. FIG. 12A shows the boom fully retracted for ease of installation and portability. Fully retracting the boom 30 may facilitate positioning the crane 5 relative to the load. FIG. 12B shows the boom 30 in a partially extended state, and FIG. 12C shows the boom in a fully extended state. Similar to the extendible mast 20, the boom 30 can be extended by turning a crank (not shown) to extend the boom 30, or the boom 30 can be manually extended. The boom 30 can include two, three, or any other suitable number of extendible portions, such as telescoping portions, depending on the design of the crane 5.

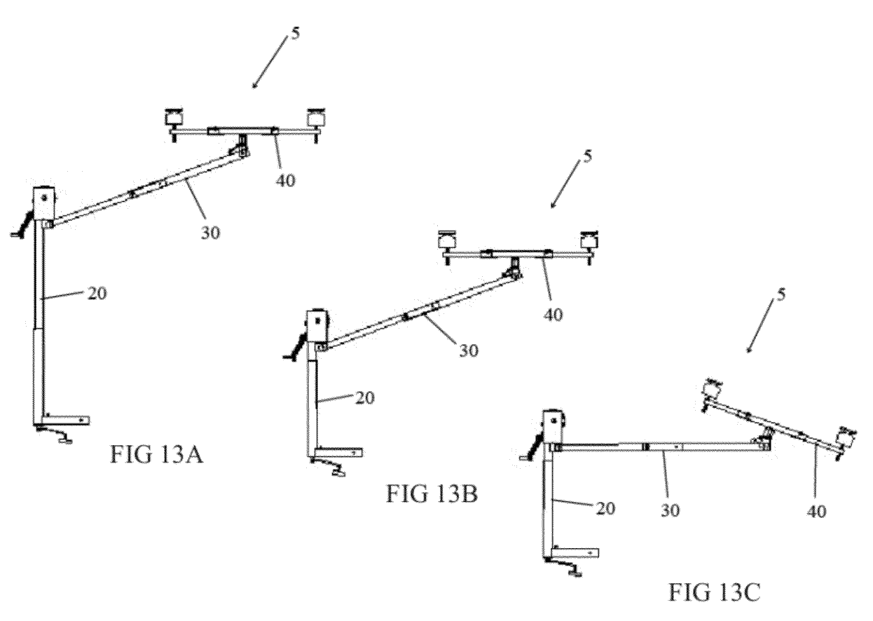

FIGS. 13A-13C illustrate another embodiment of a crane 5 according to the present disclosure in which the support 40 is pivotably coupled to the boom 30. The progression from FIG. 13A to 13C shows a process of lowering the support 40 from a highest point to a lowest point. FIG. 13A shows the crane 5 with the mast 20 extended, the boom 30 raised, and the support 40 level relative to the ground. FIG. 13B shows the mast 20 retracted and the boom 30 slightly lowered relative to the mast 20. The support 40 is still generally level relative to the ground to support the load (e.g., vehicle attachment). FIG. 13C shows the crane 5 with the boom 30 lowered to level, and the support 40 pivoting to deposit the load onto a support (not shown). The load may be a canopy for a pickup truck, and the support can be a sawhorse or another suitable support. The support 40 can be pivoted relative to the boom 30 to facilitate depositing the load onto the support.

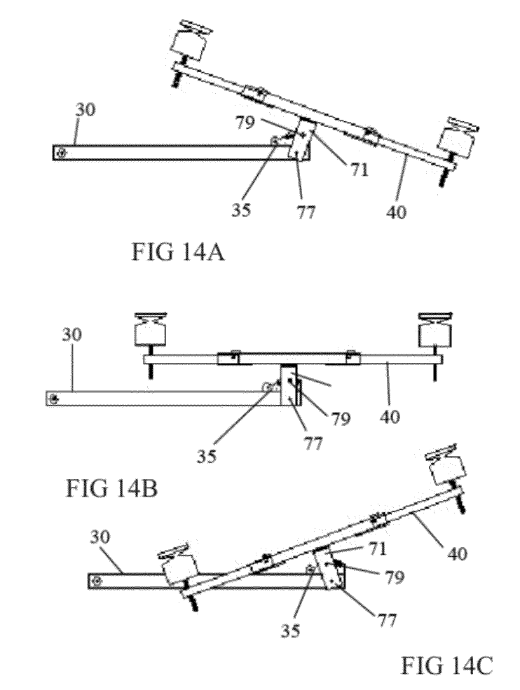

FIGS. 14A-14C illustrate a further embodiment of a crane 5 according to the present disclosure in which the support 40 is adjustably coupled to the boom 30. The support 40 has a leveler base 71 having a lower leveler base pivot 77 and an upper leveler base pivot 79. The boom 30 has a bracket 35 with several holes spaced apart throughout the bracket 35. The upper leveler base pivot 79 can be selectively coupled to one of the holes in the bracket 35 to secure the support 40 to the boom 30 at a certain angle. The angle can be chosen based on the dimensions of the deployment. For example, if the crane 5 is to be used with a pickup truck and a canopy attachment, the dimensions of the hitch, the canopy, the bed, and the supports upon which the crane 5 will deposit the canopy can all figure into the angle at which the support 40 is mounted to the boom 30. With the proper angle chosen, the support 40 can remain at the fixed angle relative to the boom 30 and without tipping as the boom 30 is raised and lowered.

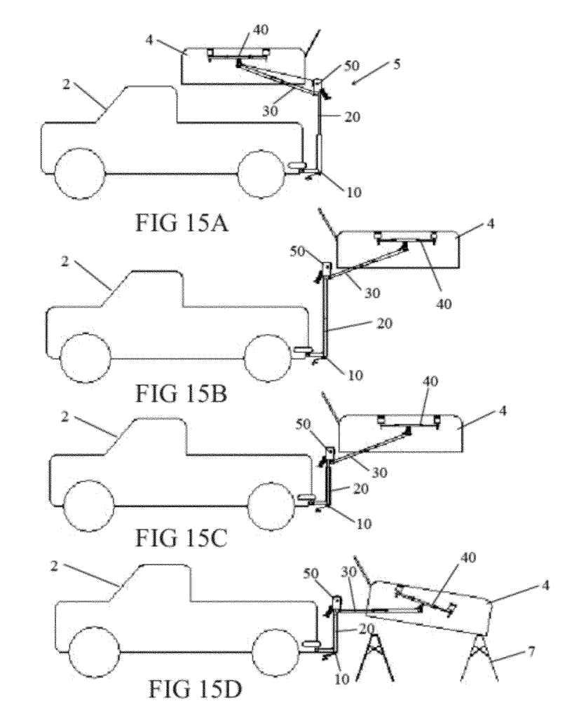

FIGS. 15A-15D illustrate a deployment of a crane 5 according to embodiments of the present disclosure. In FIG. 15A the crane 5 is mounted to the hitch of the vehicle 2, the boom 30 is extended into the canopy 4 and the boom 30 is raised up by the elevator mechanism 50 to engage an interior surface of the canopy 4. The mast 20 is extended vertically and telescopically. In FIG. 15B the crane 5 is rotated to move the canopy 4 away from the vehicle 2. The mast 20 can facilitate this rotation by the half round shown in FIGS. 8A and 8B, or by another suitable rotation mechanism. In FIG. 15C the mast 20 is telescopically retracted to lower the canopy 4. In FIG. 15D the boom 30 is lowered and the canopy 4 is rested on supports 7. The support 40 is maintained at a fixed angle relative to the boom 30 for added stability. In other embodiments, the boom 30 may include a leveler arm and a linkage and the support 40 may pivot relative to the boom 30 to support the canopy 4 level as the boom 30 is raised and lowered. The reverse operation of FIGS. 15A-15D can be performed to install the attachment 4 to the vehicle 2.

While the preferred embodiment of the invention has been illustrated and described, as noted above, many changes can be made without departing from the spirit and scope of the invention. For example, the crane can be made of steel or another suitable material. The elevator mechanism can be manually powered, or can include a motor of some kind to assist in raising, lowering, and/or rotating the crane. The crane can be used to lift canopies for pickup trucks or any other suitable load. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A crane for a attachment to a vehicle, the crane comprising:
a base stem attachable to a vehicle hitch;
a mast extending upwardly from the base unit, the mast having an axis;
a boom having a proximal end pivotably mounted to the mast and a distal end extending from the mast, the boom having a transverse lateral axis, wherein the boom is pivotable about the transverse lateral axis to raise and lower the distal end of the boom, and wherein the boom is further pivotable about the axis of the mast;
a support coupled to the distal end of the boom and configured to engage the attachment; and
a lift coupled to the boom to elevate the distal end of the boom to raise the attachment away from the vehicle, wherein the boom is further configured to pivot about the axis of the mast to move the attachment on or off the vehicle.

2. The crane of claim 1, further comprising a ground support coupled to the base stem and configured to engage the ground to further support the crane.

3. The crane of claim 1 wherein the vehicle is a pick-up truck and the attachment is a bed attachment.

4. The crane of claim 1 wherein the lift comprises a winch and a cable connected to the winch and to the distal end of the boom, wherein retracting the cable into the winch elevates the distal end of the boom.

5. The crane of claim 1 wherein the support comprises:
a support base;
one or more extension arms extensibly coupled to the support base, wherein the extension arms are movable between an extended position and a retracted position; and
attachment engagement pads coupled to ends of the extension arms and configured to engage the attachment to lift the attachment relative to the vehicle.

6. The crane of claim 6 wherein the extension arms are pivotably coupled to the support base.

7. The crane of claim 1, further comprising:
a leveler base coupled to the distal end of the boom and to the support;
a leveler arm coupled to the leveler base and to the mast, wherein the mast, the boom, the leveler base, and the leveler arm define a four bar linkage, and wherein the elevator mechanism is configured to move the four bar linkage about the transverse lateral axis to raise and lower the support.

8. The crane of claim 1, further comprising a wedge positioned at the distal end of the boom and configured to support the support when the support is angled relative to the boom.

9. The crane of claim 1 wherein the boom is vertically adjustable along the mast.

10. The crane of claim 1 wherein the support comprises a hook.

11. A method of installing an attachment to a vehicle, the method comprising:
securing a crane base unit to a hitch of the vehicle;
positioning a boom of the crane relative to the attachment to support the attachment with a support engaging the attachment;
elevating the boom of the crane with the support engaging the attachment;
rotating the boom relative to the crane to align the attachment with the vehicle; and
lowering the boom and the support and securing the attachment to the vehicle.

12. The method of claim 12, further comprising removing the crane and collapsing the crane for storage.

13. The method of claim 12 wherein securing the crane base unit to the vehicle further comprises supporting the crane on the ground.

14. The method of claim 12 wherein the attachment comprises a canopy for a pickup truck, and wherein positioning the boom relative to the attachment comprises positioning the boom and the support within the canopy.

15. The method of claim 12, further comprising extensibly adjusting at least one of a boom and a mast of the crane.

16. A crane, comprising:
a base configured to attach to a hitch of a vehicle;
an extendible mast extending upwardly from the base and being upwardly extendible;
an extendible boom having a proximal end and a distal end, the extendible boom extending from the mast at an adjustable angle with the proximal end coupled to the mast;
a support coupled to the distal end of the boom, the support comprising a support base and extendible arms, the extendible arms being retractable and extendable from the support base; and
a mechanical lift coupled to the mast and the boom and configured to raise the boom and the support, wherein the support and the extendible boom are configured to rotate about the mast while carrying a load.

17. The crane of claim 17 wherein the support is pivotably mounted to the distal end of the boom.

18. The crane of claim 17 wherein the support is secured to the boom at a fixed angle relative to the boom.

19. The crane of claim 19 wherein the fixed angle permits the boom to raise and lower a given load a given angular distance without tipping the load.

20. The crane of claim 17 wherein at least one of the extendible boom and extendible mast is extendible by turning a crank.
